(19) United States
(12) Patent Application Publication
(10) Pub. No.: US 2025/0350568 A1
(43) Pub. Date: Nov. 13, 2025

(54) APPARATUS AND METHOD FOR LOW LATENCY OFF-GRID PEER-TO-PEER TRACKING AND MESSAGING

(71) Applicant: Metrazi, LLC, Corona, CA (US)

(72) Inventors: Paymon Shirazi, Corona, CA (US); Shayan Shirazi, Corona, CA (US)

(21) Appl. No.: 18/657,292

(22) Filed: May 7, 2024

(51) Int. Cl. H04L 51/046; H04L 67/104

(52) U.S. Cl. CPC H04L 51/046; H04L 67/104

(57) ABSTRACT

Aspects relate to an off-grid locator device to enhance tracking and messaging capabilities with a partner off-grid locator device. The off-grid locator device may comprise: a global navigation receiver to receive geolocation data from a satellite to determine a geolocation of the off-grid locator device; a radio transceiver; and a processor coupled to the global navigation receiver and the radio transceiver. The processor may be configured to: upon receiving the geolocation data from the global navigation receiver and determining the geolocation of the off-grid locator device, commanding the radio transceiver to transmit the geolocation of the off-grid locator device to the partner off-grid locator device; and calculating partner data associated with a distance and a bearing relative to the partner off-grid locator device based upon the geolocation of the off-grid locator device.

### TECHNICAL FIELD

The technology discussed below relates generally to wireless communication, and more particularly, to an apparatus and method for low latency off-grid peer-to-peer tracking and messaging.

### INTRODUCTION

With the recent increase in outdoor activities after the COVID-19 pandemic, the demand for robust tracking and messaging technology for use in activities such as hiking, snow-sports, off-roading, and music festivals have garnered heavy interest. To accommodate this increased demand, wireless technology products have shifted focus towards keeping users in contact through short text messages-rather than offering robust solutions with low-latency location sharing updates and messaging. These types of devices are commonly in the form of satellite communicators. These types of devices are not peer-to-peer by nature of operation, as outgoing messages from these devices are transmitted to destinations through a satellite network and then subsequently transmitted to destinations via cellular networks. Although satellite communicators provide geolocation services to users, they cannot be easily shared at low latency with others as they require appropriate satellite availability and time to transfer from the satellite to cellular networks averaging about a few minutes to transmit geolocations.

Industrial asset tracking services exist whereby geolocations are updated through onboard global navigation satellite system (GNSS) or global positioning system (GPS) receivers. In these systems, last known geolocations are submitted to end users through Wi-Fi and/or cellular networks. Similarly, smartphone devices equipped with cellular-assisted GNSS/GPS receivers fall within this category for consumer use. These networks are able to relay geolocation data at lower latencies when compared to satellite communicators. However, regardless of the transmitting network, the geolocations must transfer through a network (e.g., cellular or Wi-Fi) and are susceptible to connection loss in the absence or flooding of these heavily utilized networks.

Short-range trackers (e.g., less than 500 ft) have also become an attractive and cost-effective solution for navigating towards users or lost-items off-network. These devices possess radio-frequency based ranging modules that calculate distances based off of time-of-flight (ToF) and/or distances and directions through measured doppler-phase shifts. They offer a robust solution in short range applications but are susceptible to strong environmental interference, lack messaging capabilities, and are unable to provide geolocations lacking GNSS/GPS receivers. Additionally, their shorter operating ranges are not ideal for many outdoor activities, even in relatively flat terrains.

Therefore, a need exists for a robust solution capable of providing low latency tracking services, as well as messaging, at short to long ranges (e.g., less than 10 miles) between users in environments with poor connectivity or completely lacking traditional communication networks. These types of solutions could accommodate the growing demand for low-latency connectivity and location-based tracking for enthusiasts in outdoor environments, which often lack adequate cellular reception and/or access to Wi-Fi networks.

### BRIEF SUMMARY OF SOME EXAMPLES

The following presents a summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Aspects described herein relate to an integrated off-grid locator device designed to enhance tracking and messaging capabilities for users in the absence of traditional communication networks such as Wi-Fi and cellular. Aspects described herein facilitate peer-to-peer tracking and messaging without the use of cellular or Wi-Fi networks by transceiving digital radio packets containing geolocations (e.g., longitude, latitude, altitude) obtained by an onboard global navigation satellite system receiver between two or more off-grid locator devices that operate similarly. Sharing geolocations over radio frequencies enables the distances and relative bearings between two or more similar off-grid locator devices to be determined. These geolocations and distances and relative bearings of the off-grid locator devices can be displayed to users or transferred to external devices such as computers and smartphones for further analysis and or visualization. Therefore, aspects described herein offer a viable pathway for reliable peer-to-peer tracking and communication in the absence and/or flooding of conventional communication networks in various contexts with extremely low latency.

In one example, an off-grid locator device to enhance tracking and messaging capabilities with a partner off-grid locator device is provided. The off-grid locator device may comprise: a global navigation receiver to receive geolocation data from a satellite to determine a geolocation of the off-grid locator device; a radio transceiver; and a processor coupled to the global navigation receiver and the radio transceiver. The processor may be configured to: upon receiving the geolocation data from the global navigation receiver and determining the geolocation of the off-grid locator device, commanding the radio transceiver to transmit the geolocation of the off-grid locator device to the partner off-grid locator device; and calculating partner data associated with a distance and a bearing relative to the partner off-grid locator device based upon the geolocation of the off-grid locator device.

In another example, a method operable at an off-grid locator device to enhance tracking and messaging capabilities with a partner off-grid locator device is provided. The method may comprise: determining a geolocation of the off-grid locator device based upon receiving geolocation data from a satellite via a global navigation receiver; commanding a radio transceiver to transmit the geolocation of the off-grid locator device to the partner off-grid locator device; and calculating partner data associated with a distance and a bearing relative to the partner off-grid locator device based upon the geolocation of the off-grid locator device.

In yet another example, an off-grid locator device to enhance tracking and messaging capabilities with a partner off-grid locator device is disclosed that comprises: means for determining a geolocation of the off-grid locator device based upon receiving geolocation data from a satellite via a global navigation receiver; means for commanding a radio transceiver to transmit the geolocation of the off-grid locator device to the partner off-grid locator device; and means for calculating partner data associated with a distance and a bearing relative to the partner off-grid locator device based upon the geolocation of the off-grid locator device.

These and other aspects will become more fully understood upon a review of the detailed description, which follows. Other aspects, features, and examples will become apparent to those of ordinary skill in the art, upon reviewing the following description of specific, exemplary examples of in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices, systems, and methods.

### BRIEF DESCRIPTION OF THE DRAWINGS

FIG. 1 illustrates a simplified example of a wireless communication system.

FIG. 2 is a diagram illustrating an example of a pair of off-grid locator devices designed to enhance tracking and messaging capabilities for users in the absence of traditional communication networks such as Wi-Fi and cellular, according to some aspects.

FIG. 3 is a diagram illustrating an example of an off-grid locator device, according to some aspects.

FIG. 4 is a diagram showing an example of some of the components of the off-grid locator device, according to some aspects.

FIG. 5 is a diagram showing an example of some of the components, processes, and interaction of the components, of the of the off-grid locator device, according to some aspects.

FIG. 6 is a diagram showing an example of protocols that may be implemented by the processor of the off-grid locator device to obtain partner data, according to some aspects.

FIG. 7 is a diagram showing an example of how incoming radio transmissions are handled to determine if they are intended for the off-grid locator device, according to some aspects.

FIG. 8 is a diagram showing an example of a message sending a confirmation protocol between a transmitting off-grid locator device and a receiving off-grid locator device that are paired before sending messages, according to some aspects.

FIG. 9 are graphs showing a received signal strength indicator (RSSI) versus the log-base-10 of the distance (e.g., LOG (DISTANCE)) for the radio and the Wi-Fi/BLE frequencies, top graph, and the bottom graph shows the quality of the signal determined using the signal-to-noise ratio (SNR) margin and the RSSI, according to some aspects.

FIG. 10 is a diagram showing incorporation of grid declination to correct for the difference between the compass' magnetic north and the grid north using the off-grid locator device's geolocation, according to some aspects.

FIG. 11 is a flow chart of an example method operable at an off-grid locator device to enhance tracking and messaging capabilities with a partner off-grid locator device, according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects described herein relate to an integrated off-grid locator device designed to enhance tracking and messaging capabilities for users in the absence of traditional communication networks such as Wi-Fi and cellular. Aspects described herein facilitate peer-to-peer tracking and messaging without the use of cellular or Wi-Fi networks by transceiving digital radio packets containing geolocations (e.g., longitude, latitude, altitude) obtained by an onboard global navigation satellite system receiver between two or more off-grid locator devices that operate similarly. Sharing geolocations over radio frequencies enables the distances and relative bearings between two or more similar off-grid locator devices to be determined. These geolocations and distances and relative bearings of the off-grid locator devices can be displayed to users or transferred to external devices such as computers and smartphones for further analysis and or visualization. Therefore, aspects described herein offer a viable pathway for reliable peer-to-peer tracking and communication in the absence and/or flooding of conventional communication networks in various contexts with extremely low latency.

Further, aspects described herein illustrate implementable techniques for users to track and log their own off-grid locator device's geolocation and their paired off-grid locator device's geolocations in challenging outdoor off-grid environments. Additionally, users are able to send and receive text messages without the need for traditional cellular and Wi-Fi/BLE (Bluetooth low energy) networks through the aspects described herein.

Aspects of the disclosure to be described, overcome the limitations of current technology in enabling completely precise off-grid tracking with messaging services in the absence of traditional cellular and Wi-Fi networks that have extremely low latency.

In one example, an off-grid locator device to enhance tracking and messaging capabilities with a partner off-grid locator device is provided. The off-grid locator device may comprise: a global navigation receiver to receive geolocation data from a satellite to determine a geolocation of the off-grid locator device; a radio transceiver; and a processor coupled to the global navigation receiver and the radio transceiver. The processor may be configured to: upon receiving the geolocation data from the global navigation receiver and determining the geolocation of the off-grid locator device, commanding the radio transceiver to transmit the geolocation of the off-grid locator device to the partner off-grid locator device; and calculating partner data associated with a distance and a bearing relative to the partner off-grid locator device based upon the geolocation of the off-grid locator device.

In one example, as will be described, the radio transceiver transmits and receives data in connection with the partner off-grid locator device over a direct peer-to-peer radio connection, without utilizing Wi-Fi or cellular communication networks. In one example, the global navigation receiver comprises a global navigation satellite system (GNSS) receiver or a global positioning system (GPS) receiver. In one example, the geolocation includes longitude, latitude, and altitude. In one example, a display is provided, in which, the processor is further configured to command the display to display the off-grid locator device geolocation, the partner off-grid locator device geolocation, and the partner data associated with the distance and the bearing relative to the partner off-grid locator device. In one example, the processor is further configured to command the off-grid locator device geolocation, the partner off-grid locator device geolocation, and the partner data associated with the distance and the bearing relative to the partner off-grid locator device be transmitted to an external component. In one example, an external component includes at least one of a server, a network, a mobile phone, an external display, a portable processing system, or a non-portable processing system. In one example, the processor is further configured to track and log: its own off-grid locator device geolocations and partner off-grid locator device geolocations. In one example, the processor is further configured to command transmission of messages through the radio transceiver to the partner off-grid locator device. In one example, the transmission and reception of messages are based upon peer-to-peer verification and confirmation over digital radio packets.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station or UE), end-user devices, etc. of varying sizes, shapes and constitution.

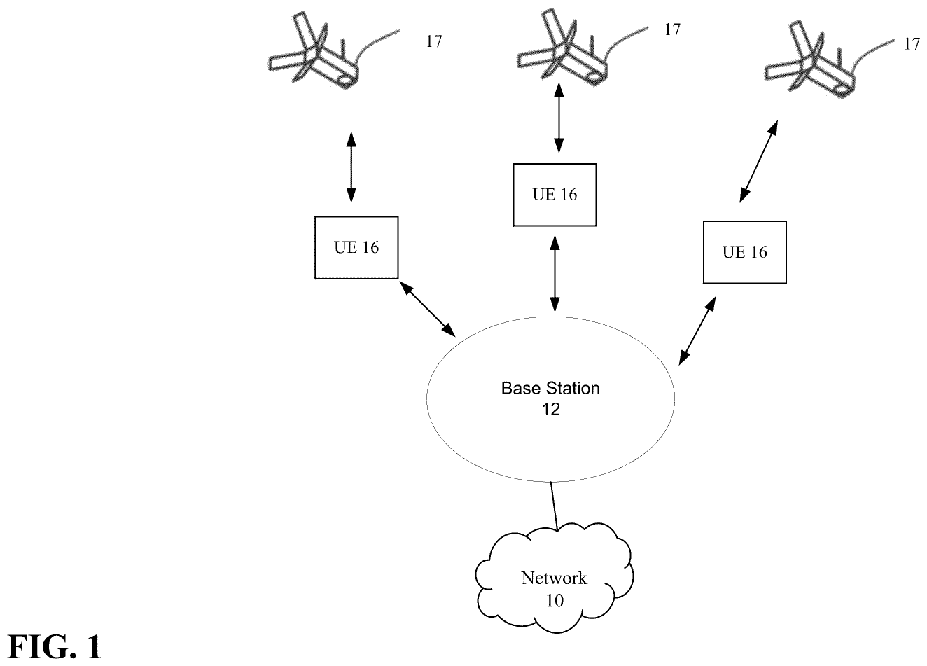

FIG. 1 illustrates a simplified example of a wireless communication system. It should be noted that the system of FIG. 1 is merely one example of a possible system, and that features of this disclosure may be implemented in any of various systems, as desired.

As shown, the example wireless communication system includes a base station 12 which communicates over a transmission medium with one or more user devices 16. Each of the user devices may be referred to herein as a “user equipment” (UE). Thus, the user devices 16 are referred to as UEs or UE devices.

The base station (BS) 12 may be a base transceiver station (BTS) or cell site (a “cellular base station”) and may include hardware that enables wireless communication with the UEs 16. It should be appreciated that only one base station is shown for simplicity, but multiple base stations may be present in typical wireless communication environments.

The communication area (or coverage area) of the base station may be referred to as a “cell.” The base station 12 and the UEs 16 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 12 is implemented in the context of LTE, it may alternately be referred to as an ‘eNodeB’ or ‘eNB’. Note that if the base station 12 is implemented in the context of 5G NR, it may alternately be referred to as ‘gNodeB’ or ‘gNB’.

As shown, the base station 12 may also be equipped to communicate with a network 10 (e.g., a core network of a cellular service provider, a telecommunication network such as a public switched telephone network (PSTN), and/or the Internet, among various possibilities). Thus, the base station 12 may facilitate communication between the user devices and/or between the user devices and the network 100. In particular, the cellular base station 12 may provide UEs 16 with various telecommunication capabilities, such as voice, SMS and/or data services.

Base station 12 and other similar base stations (e.g., only one base station shown for simplicity) operating according to the same or a different cellular communication standard may thus be provided as a network of cells, which may provide continuous or nearly continuous overlapping service to UEs 16 and similar devices over a geographic area via one or more cellular communication standards.

Thus, while base station 12 may act as a “serving cell” for UEs 16, as illustrated in FIG. 1, each UE 106 may also be capable of receiving signals from (and possibly within communication range of) one or more other cells (which might be provided by other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size.

Base station 12 may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

It should be noted that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi, peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.).

The UE 106 may also or alternatively be configured to communicate using one or more global navigational satellite systems 17 (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

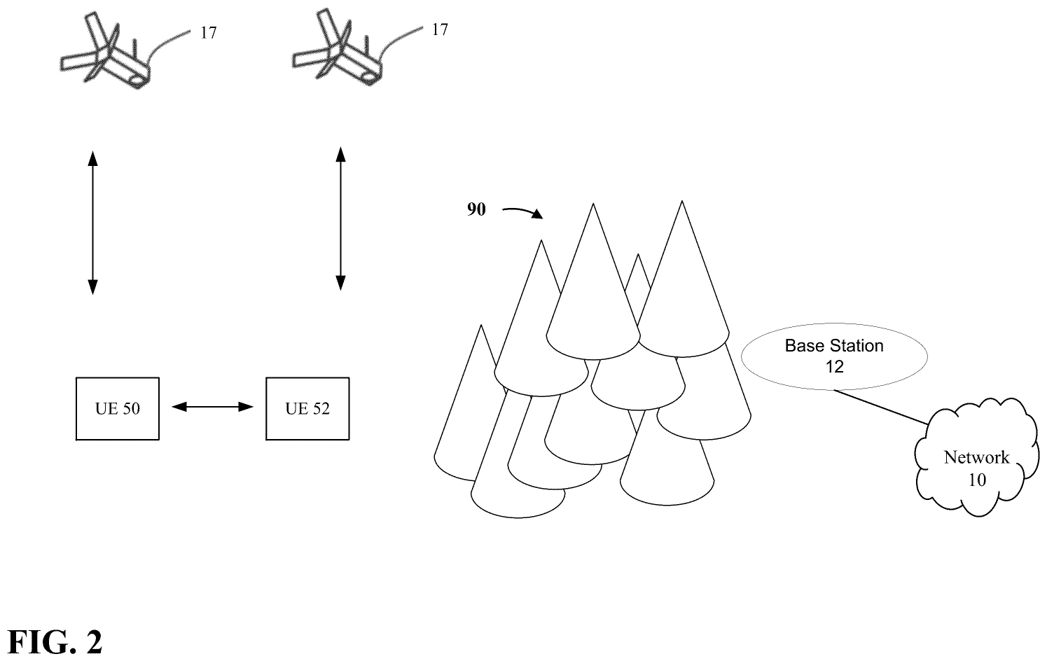

FIG. 2 is a diagram illustrating an example of a pair of off-grid locator devices (UEs 50 and 52) designed to enhance tracking and messaging capabilities for users in the absence of traditional communication networks such as Wi-Fi and cellular, according to some aspects. As previously described with reference to FIG. 1, in a typical wireless communication system a UE may have a connection via a base station 12 to communicate with other UEs and the network. However, aspects described herein facilitate peer-to-peer tracking and messaging without the use of cellular or Wi-Fi networks between two or more off-grid locator devices 50 and 52, where there is no access to a base station 12. As an example, a pair of hikers may be prevented by a mountain range 90 from access to a base station 12 and network 100. It should be appreciated that off-grid locator devices 50 and 52 may be referred to as UEs and the terms are used interchangeably.

As has been described there are many outdoor activities that need robust tracking and messaging technology, such as, hiking, snow-sports, off-roading, etc., in which, due to location away from typical wireless communication via base stations 12 or Wi-Fi, communication is still needed between UEs (e.g., including location between UEs and messaging). Aspects of the disclosure to be described overcome the limitations of current technology in enabling completely precise off-grid tracking with messaging services in the absence of traditional cellular and Wi-Fi networks that have extremely low latency.

In one aspect, off-grid locator devices 50 and 52 transceive digital radio packets containing geolocations (e.g., longitude, latitude, altitude) obtained by an onboard global navigation satellite system receiver on each off-grid locator devices 50 and 52 from satellites 17 between each other. By sharing geolocations between the off-grid locator devices 50 and 52 over radio frequencies, this enables the distances and relative bearings between two or more similar off-grid locator devices 50 and 52 to be determined. These geolocations and distances and relative bearings of the off-grid locator devices 50 and 52 can be displayed to users of the locator devices on their display devices and/or can be transferred to external devices such as computers and smartphones for further analysis and or visualization. Therefore, aspects described herein offer a viable pathway for reliable peer-to-peer tracking and communication in the absence of conventional communication networks (e.g., base stations 12, Wi-Fi, networks 10) in various contexts with extremely low latency. Further, aspects described herein illustrate implementable techniques for users to track and log their own off-grid locator device's geolocation and paired off-grid locator device's geolocations in challenging outdoor off-grid environments. Additionally, users are able to send and receive text messages without the need for traditional cellular and Wi-Fi/BLE (Bluetooth low energy) networks.

Accordingly, a robust solution to provide low latency tracking services, as well as messaging, at short to long ranges (e.g., less than 10 miles) between users utilizing off-grid locator devices 50 and 52 in environments with poor connectivity or completely lacking traditional communication networks is provided. These types of solutions accommodate the growing demand for low-latency connectivity and location-based tracking for enthusiasts in outdoor environments, which often lack adequate cellular reception and/or access to Wi-Fi networks.

It should be appreciated that although two off-grid locator devices 50 and 52 are shown, as an example, that any suitable number of off-grid locator devices may be utilized according to aspects of the disclosure.

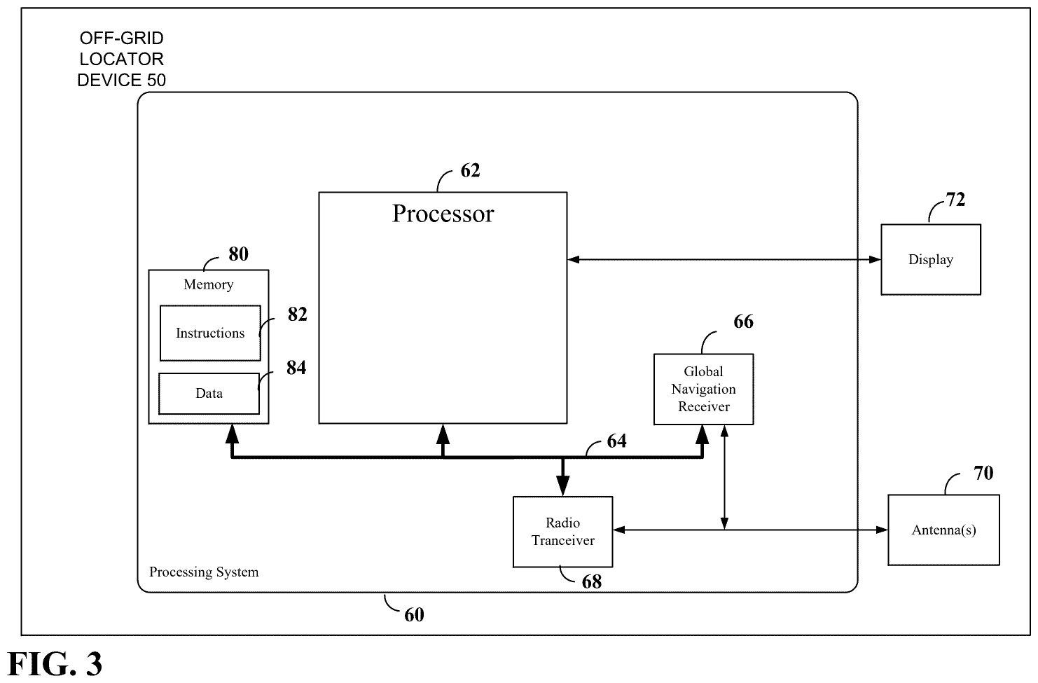

FIG. 3 is a diagram illustrating an example of an off-grid locator device 50 according to some aspects. As has been described, the off-grid locator device 50 is used to enhance tracking and messaging capabilities with a partner off-grid locator device 52. In one aspect the off-grid locator device 50 may include a processing system 60 that includes: a processor 62; a global navigation receiver 66; a radio transceiver 68; and memory 80. The global navigation receiver 66 and radio transceiver 68 may be coupled to antennas 70 for receipt and transmission data from satellites, and other off-grid locator devices, as will be described. Processor 62 may be coupled to the global navigation receiver 66, the radio transceiver 68, and memory 80 via bus 64. Memory 80 may include instructions 82 and data 84 for the processor 62 to implement functionality to be hereafter described. Further, processor 62 may be coupled to a display 72 to display data to a user.

In one aspect, the global navigation receiver 66 receives geolocation data from a satellite 17 (FIG. 2) via antenna(s) 70 to determine a geolocation of the off-grid locator device 50. In one example, the geolocation may include longitude, latitude, and altitude of the off-grid locator device 50. As has been described, processor 62 is coupled to the global navigation receiver 66 and the radio transceiver 68. Processor 62 may be configured to: upon receiving the geolocation data from the global navigation receiver 66 and determining the geolocation of the off-grid locator device, commanding the radio transceiver 68 to transmit the geolocation of the off-grid locator device to the partner off-grid locator device 52 via antenna(s) 70. Processor 62 may be further configured to: calculate partner data associated with a distance and a bearing relative to the partner off-grid locator device 52 based upon the geolocation of the off-grid locator device. Processor 62, as utilized in the off-grid locator device 50, may be used to implement any one or more of the processes described herein. In some examples, the memory 80 may include instructions 82 and data 84 that may be utilized by the processor 62 when executing software to implement the functions described herein.

In one aspect, the radio transceiver 68 transmits and receives data in connection with the partner off-grid locator device 52 over a direct peer-to-peer radio connection, without utilizing Wi-Fi or cellular communication networks. In one example, the global navigation receiver 66 comprises a global navigation satellite system (GNSS) receiver or a global positioning system (GPS) receiver. In one example, the processor 62 is further configured to command the display 72 to display the off-grid locator device geolocation, the partner off-grid locator device geolocation, and the partner data associated with the distance and the bearing relative to the partner off-grid locator device. In one example, the processor 62 is further configured to command the off-grid locator device geolocation, the partner off-grid locator device geolocation, and the partner data associated with the distance and the bearing relative to the partner off-grid locator device be transmitted to an external component. In one example, an external component includes at least one of a server, a network, a mobile phone, an external display, a portable processing system, or a non-portable processing system. In one example, processor 62 is further configured to track and log: its own off-grid locator device geolocations and partner off-grid locator device geolocations. In one example, the processor 62 is further configured to command transmission of messages through the radio transceiver 68 to the partner off-grid locator device 52. In one example, the transmission and reception of messages are based upon peer-to-peer verification and confirmation over digital radio packets.

By utilizing these implementations by the off-grid locator device 50 and the partner off-grid locator device 52, tracking and messaging capabilities between the off-grid locator device and partner off-grid locator device 52 are enhanced, and a robust solution to provide low latency tracking services, as well as messaging, at short to long ranges (e.g., less than 10 miles) between users utilizing the off-grid locator devices 50 and 52 in environments with poor connectivity or completely lacking traditional communication networks is provided. These types of solutions accommodate the growing demand for low-latency connectivity and location-based tracking for enthusiasts in outdoor environments, which often lack adequate cellular reception and/or access to Wi-Fi networks. It should be appreciated that although a pair of off-grid locator devices 50 and 52 that any number of off-grid locator devices may be in communication with one another to exchange geolocation data, tracking information relative each other, and to exchange messages.

Further, because radio transceiver circuitry is utilized for short to long ranges (e.g., less than 10 miles), expensive cellular circuitry and antennas are not required for traditional cell-phone communication, such that the cost of off-grid locator devices are reduced. At the same time, the off-grid locator cell device can be connected to a user's cell-phone for cellular communication, as will be described. Also, the off-grid locator devices can still be utilized in heavily flooded cell networks for geolocation, tracking, messaging, etc. Therefore, aspects described herein offer a viable pathway for reliable peer-to-peer tracking and communication in the absence and/or flooding of conventional communication networks in various contexts with extremely low latency.

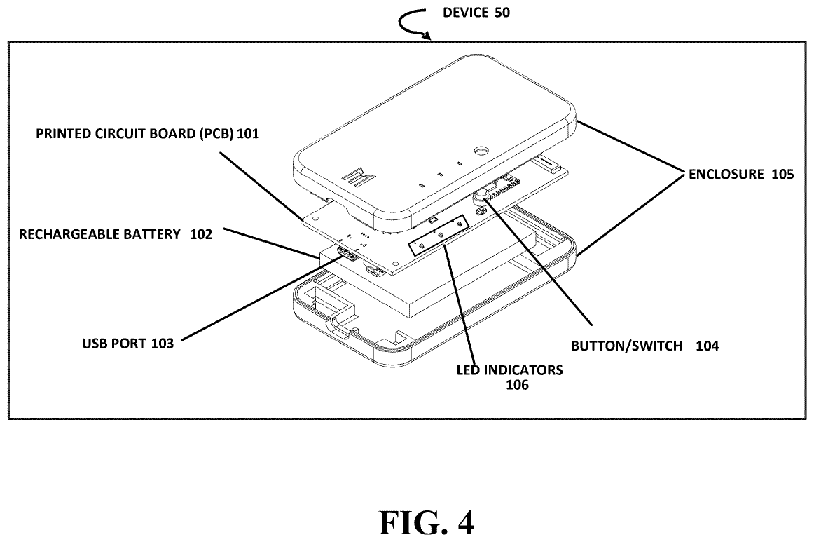

FIG. 4 is a diagram showing an example of some of the components of the off-grid locator device 50, according to some aspects. As an example, FIG. 4 shows that off-grid locator device 50 may include an enclosure 105 and a printed circuit board (PCB) 101, or a similar system, in which, electrical components such as integrated circuits and circuit elements can be fixed to and thereby coupled to each other, including processor 62, one or more rechargeable batteries 102, a USB port 103, and an on/off switch or button 104. It should be appreciated that this is just an example of a PCB 101 that may be utilized to include the electronic components of the off-grid locator device 50 including the previously described components of FIG. 3 including a processing system 60 comprising one or more of: a processor 62, a global navigation receiver 66, a radio transceiver 68, antennas 70, memory 80, etc. In particular, it should be appreciated that PCB 101 is just an example of an electronic system, in which, electrical components such as integrated circuits and circuit elements can be fixed and coupled to each other, for the previously described components, and that any suitable type of electronic system to operate these and/or other components may be utilized.

As an example, enclosure 105 may be a suitably shaped component. As an example, enclosure 105 may be a rectangular-shaped structure that may include a bottom and top portion that are coupled to one another to contain and mount the PCB 101 and the rechargeable battery 102. The enclosure 105 may be composed of plastic, ceramic, metal or a composite material—as to a combination of one or more of these materials, to house and protect PCB 101 and the other internal components shown in FIG. 4 from external damage or element for an example dust or water. The components within off-grid locator device 50 can be secured to or within the enclosure 105 by screws, epoxy, and snap-fittings and/or alternatively mounted to the PCB 101 by design. It should be noted that within enclosure 105, a USB port 103 or similar charging mechanism may be utilized to recharge battery 102 to power the off-grid locator device 50. It should be appreciated that USB port 103 can be used as a charging port for recharging battery 102 and as an interface to external components.

In one example, with the actuation of a digital or analog-based power-on button or switch 104, the off-grid locator device 50 may be powered-on for operation upon user discretion. The power-on button or switch 104 may extend through an opening of the top portion of the enclosure 105. Some optional components, although not all explicitly shown in this figure, to enhance the off-grid locator device 50 for operation by users may include: organic and light-emitting diode (O/LED) indicators 106, an alphanumeric keypad to record user inputs, an integrated display to show the user information, and additional memory to store user geolocation logs and messages information. These additional components will be discussed in more detail, hereafter. As to the LED indicators 106, they may be shown to users through adjacent openings of the top portion of the enclosure 105.

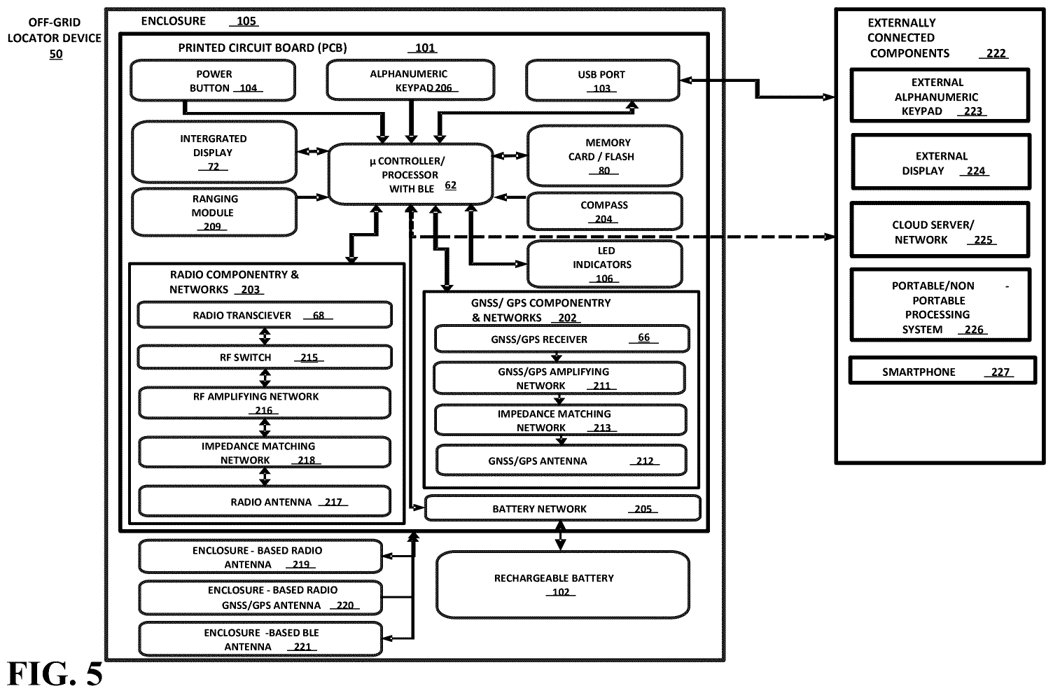

FIG. 5 is a diagram showing an example of some of the components, processes, and interaction of the components of the PCB 101 of the off-grid locator device 50, according to some aspects. FIG. 5 shows examples of interfaces of the off-grid locator device 50 with optional externally connected components and systems 222, as will be described in more detail hereafter. It should be noted, that in one example aspect, PCB 101 in enclosure 105 of off-grid locator device 50 includes previously described components of off-grid locator device 50, previously described with reference to FIG. 3 that include a processing system 60 that comprises one or more of: a processor 62, a global navigation receiver 66, a radio transceiver 68, antennas 70, an integrated display 72, a memory 80, etc.

The examples described in FIG. 5, describe more particular defined aspects. As one example aspect, PCB 101 includes at least one processor 62. In one example aspect, processor 62 may be at least one central processing unit (CPU) or microcontroller with either or both Wi-Fi and or bluetooth low energy (BLE) and internal read-only and/or flash memory functionalities. In one example aspect, PCB 101 may include a multi global navigation satellite system (GNSS) and/or global positioning system (GPS) system componentry & networks 202, radio transceiver componentry & networks 203, a compass 204, a battery network 205 (e.g., which may contain integrated circuits to charge rechargeable battery 102), a power button or switch 104, and a USB port 103 that may be assembled to the enclosure 105 while remaining electrically connected to the PCB 101.

Further, in one aspect, optional example components may include: an alphanumeric keypad 206, an integrated display 72, LED light indicators 106, memory 80, such as, a memory card or flash memory, and a dedicated ranging module 209. It should be appreciated that these components may be electrically coupled to PCB 101. Additionally, it should be appreciated that these components mounted on PCB 101 may be electrically coupled with the processor 60 via analog or digital coupling paths. These coupling paths are outlined by the solid arrows in FIG. 5. In this context, analog signals may consist of electrical voltages, currents, resistances, and impedances, whereas digital signals may include quad and serial peripheral interface (QSPI, SPI), inter-integrated circuit (I2C), universal asynchronous transmitter receiver (UART), serial communication, and recommended standard 232 (RS-232) digital signals, as examples. These coupling paths allow for the transmitting and receiving of data and/or instructions from electrical components mounted onboard the PCB 101 to the processor 62 in order to implement the functions and implementations described herein.

In one example aspect, the GNSS/GPS componentry & networks 202 may include global navigation receiver 66 (e.g., hereafter referred to as GNSS/GPS receiver 66), a GNSS/GPS amplifying network 211 (e.g., which may be in the form of a low noise amplifier (LNA) coupled to a filter (e.g., SAW filter)), a GNSS/GPS antenna 212, and an optional impedance matching network 213 to tune the other components within the GNSS/GPS componentry & networks 202 with the antenna's recommended specifications for optimal operation. The GNSS/GPS receiver 210 may support multi-GNSS operation allowing its operation based-on incoming signals from multiple satellite constellations (e.g., GPS, GLONASS, GALILEO, etc.). Additionally, the GNSS/GPS receiver 66 may also support multi-band operation for better precision, accuracy, and reliability in poor weather conditions supporting L1-1575.42 MHz, L2-1227.60 MHz, and L5-1176.45 MHz centerline frequencies and allocated bandwidths. Alternatively, a GNSS/GPS transceiver with transmitting capabilities may also be utilized to transmit and receive L1-band GNSS/GPS signals with various satellite constellations.

In one example aspect, the radio transceiver componentry & networks 203 may include: radio transceiver 68, a RF switch 215, a RF amplifying network 216, and a radio antenna 217. Further, in some optional examples, an impedance matching network 218 to tune the other components of the radio componentry & networks 203 with the recommended specifications of the radio antenna 217 to optimize performance may be utilized.

In one example aspect, the radio transceiver componentry & networks 203 may be utilized for short to long ranges (e.g., less than 10 miles) between users utilizing off-grid locator devices 50 and 52 in environments with poor connectivity or completely lacking traditional communication networks and may operate in appropriate radio frequency bands (e.g., 150 to 1000 MHz). It should also be noted that previously described antennas 70 of FIG. 3 may include GNSS/GPS antenna 212 and radio antenna 217.

In one example aspect, the enclosure 105 may be electrically semi-conducting, partially conducting, or may contains regions that are electrically conductive, and such segments may serve as an enclosure for the antennas (e.g., radio antenna 219, GNSS/GPS antenna 220, a BLE/WiFi antenna for 221 for the processor) to therefore provide: an enclosure-based radio antenna 219, an enclosure-based GNSS/GPS 220 antenna, and an enclosure-based BLE/Wi-Fi 221 antenna.

It should be appreciated that to operate the enclosure-based antennas 219-221, they may be electrically coupled to the radio componentry & networks 203, GNSS/GPS componentry & networks 202, and processor 62 with BLE/Wi-Fi 201, respectively. These connections between the enclosure-based antennas 219-221 may be facilitated by solid electrical connections in the form of electrical wires, coaxial cables, or similar electrical connecting mechanisms, enabling connection with their respective networks (e.g., radio componentry & networks 203, GNSS/GPS componentry & networks 202, and processor 62). In some aspects, these antennas may be designed to operate within their respective regions of the electromagnetic spectrum independently or conjoined as a single antenna to support multi-band and or wide band operation by chosen design.

In one example aspect, processor 62 may be able to interface with externally connected components 222 by transmitting and receiving data (e.g., commands, information, recorded user input) to the external components 222. As an example, externally connected components 222 may include: external alphanumeric keypads or keyboards 223; external displays 224; a cloud server/network 225; a portable/non-portable processing system 226 (e.g., a computer); and/or a mobile device 227 (e.g., a cell-phone, smartphone, etc.). It should be appreciated that connections to these external connected components 222 may be established by connection through a wired or through a wireless connection to processor 62 of off-grid locator device 50. For example, connections may occur completely wirelessly or through a wired connection as illustrated by the dashed and sold lines in FIG. 5, respectively. In one example aspect, a wired connection is shown and facilitated by the USB port 103 mounted on the PCB 101, while a wireless connection may be made via the processor with BLE/WiFi functionality.

However, it should be appreciated that other connections between processor 62 and externally connected components 222 may be established by any type of indirect or direct electrical connection with the processor 62 through a connection from another component on-board the PCB 101 that is electrically connected with the central processing unit 62. Additionally, any type of suitable wireless connection between the processor 62 and externally connected components 222 may be facilitated through BLE and Wi-Fi protocols as depicted by the dashed line connecting the two by the processor equipped with Wi-Fi and or BLE protocols 62. Further, it should be appreciated that the off-grid locator device may be connected to external connected components 222 by any suitable wired or wireless connections.

Therefore, as an example, after the off-grid locator device 50 returns to an area with cellular communication through a base station, a user can connect their data through their smartphone 227 to the Internet or another smartphone. As another example, after the off-grid locator device 50 returns to a location with network access, a user can connect their data to a network (e.g., Internet, cloud server, specific network, etc.), for example, by a processing system 226 (e.g., a computer).

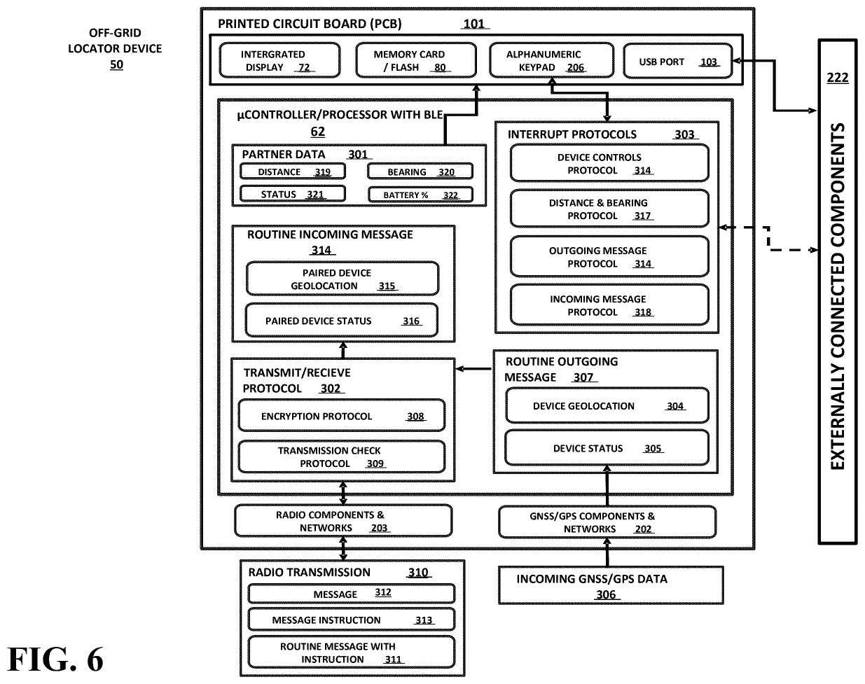

FIG. 6 is a diagram showing an example of protocols, processes, methods, etc., that may be implemented by processor 62 of the off-grid locator device 50 to obtain partner data, according to some aspects. In one aspect example, firmware of the processor 62 may be executed to obtain partner data 301. In one aspect example, processor 62 may execute firmware to determine partner data 301 including: the distance 319 and bearing 320 relative to a paired partner (e.g., paired off-grid locator device 52), status of paired off-grid locator device 321 (e.g., paired off-grid locator device 52), and remaining battery percentage of paired off-grid locator device 322 (e.g., paired off-grid locator device 52).

In one example aspect, firmware of processor 62 may operate two protocols that run concurrently: transmit/receive protocols 302 and interrupt protocols 303. The transmit/receive protocol 302 may automatically be called upon once updated device geolocations 304 are received by the GNSS/GPS components & networks 202 as new incoming GNSS/GPS data 306 from one or more satellites 17 becomes available. The updated off-grid locator device's 50 geolocation 304 and device status 305 (e.g., such as battery life or user status) are compiled into a routine outgoing message 307. The routine outgoing message 307 is sent to the encryption protocol 308 within the transmit/receive protocol 302 that is transferred to the radio components & networks 203 enabling the transmission of the encrypted information as the routine radio transmission message with instructions 311 to a paired off-grid locator device (e.g., paired off-grid locator device 52). Although one paired off-grid locator device 52 is utilized as an example, it should be appreciated that any suitable number of paired off-grid locator devices may be transmitted to.

In the event an off-grid locator device (e.g., 50, 52, etc.) receives an incoming radio transmission 310, the transmit/receive protocol 302 is responsible for decoding and identifying if the transmission is a “real” transmission (e.g., not random noise) and/or that a transmission is intended for the off-grid locator device. If it is determined that the incoming information is intended to be received by the off-grid locator device and is a type of radio transmission message 310 (e.g., message 312, message instruction 313, and/or routine message with instructions 311) then the off-grid locator device (e.g., 50, 52, etc.) proceeds to un-encrypt the radio transmission 310 through encryption protocol 308 producing the routine incoming partner message 314, which contains the paired device's geolocation 315 and the paired device's status 316 and battery percentage 322.

Once a new routine incoming partner message 314 or updated routine outgoing messages 307 are generated, the distance and bearing protocol 317 under the interrupt protocols 303 is triggered. When new information from paired partners or the device itself becomes available, new distances 319 and bearings 320 relative to the paired partner are calculated and reported to processor 62. This calculation may utilize two types of distinct 2-dimensional or 3-dimensional geolocations (e.g., longitudes, latitudes, and altitudes if 3D) and may determine the distance 319 and the bearing 320 relative to the paired device (e.g., distance and bearing between off-grid locator devices 50 and 52). It should be appreciated that various types of formulas may be utilized for these types of distances and bearings, such as, Haversine or Vincenty's formulas.

Once the distance and bearing protocol 317 has calculated the distance 319 and bearing 320 relative to paired devices, this information along with the device geolocations 304 and partner device geolocations 315 may be transferred to other components connected to the processor 62. As an example, this information may be in the form of displaying parameters on the integrated display 72, saving into memory/flash memory 80, and/or sharing with externally connected components 222 through the USB port 103 and/or wirelessly through the Wi-Fi and or BLE protocols of the processor 62, such externally connected components, as previously described, including: external displays 224; a cloud server/network 225; a portable/non-portable processing system 226 (e.g., a computer); and/or a mobile device 227 (e.g., a cell-phone, smartphone, etc.).

It should be noted that in one example aspect, interrupt protocols 303 control the outgoing message protocols 314 and incoming message protocols 315. As one example, outgoing messages may be generated through the externally connected components 222 or through optionally connected alphanumeric keypad 206. These inputs may initiate interrupt protocols 303 that may submit information through the outgoing message protocol 314. The outgoing message protocol 314 may submit this information over to the transmit/receive protocol 302 which encrypts the message through the encryption protocol 308 and transmits the message through the radio components & networks 203. The outgoing message protocol 314 works with the transmit/receive protocol 302 to ensure that the outgoing message is sent and received by paired off-grid locator devices successfully.

In the event that the transmit/receive protocol 302 identifies that the incoming radio transmission 310 is of the message instruction 313 type, it triggers the incoming message protocol 318. This protocol is responsible for stopping routine outgoing messages 307 until the transmit/receive protocol 302 and the incoming message protocols 318 have confirmed with the partner device that the message 312 was received correctly. This process un-encrypts the incoming message 312 through the encryption protocol 308 and continuously checks for successful transmission of the message 312 with the other device and sends a message instruction 313 to the partner device (e.g., off-grid locator device 52) to confirm that it was sent correctly, putting both devices into normal operation mode working with the routine messages from the off-grid locator device 50 and partner off-grid locator device 52. Similar to the partner data 301, the incoming messages 312 may be transferred to other components on the PCB 101 such as displaying information on integrated display 72, saving to memory/Flash memory 80, and with externally connected components 222 through the USB port 103 and wirelessly through the Wi-Fi and or BLE protocols of the processor 80.

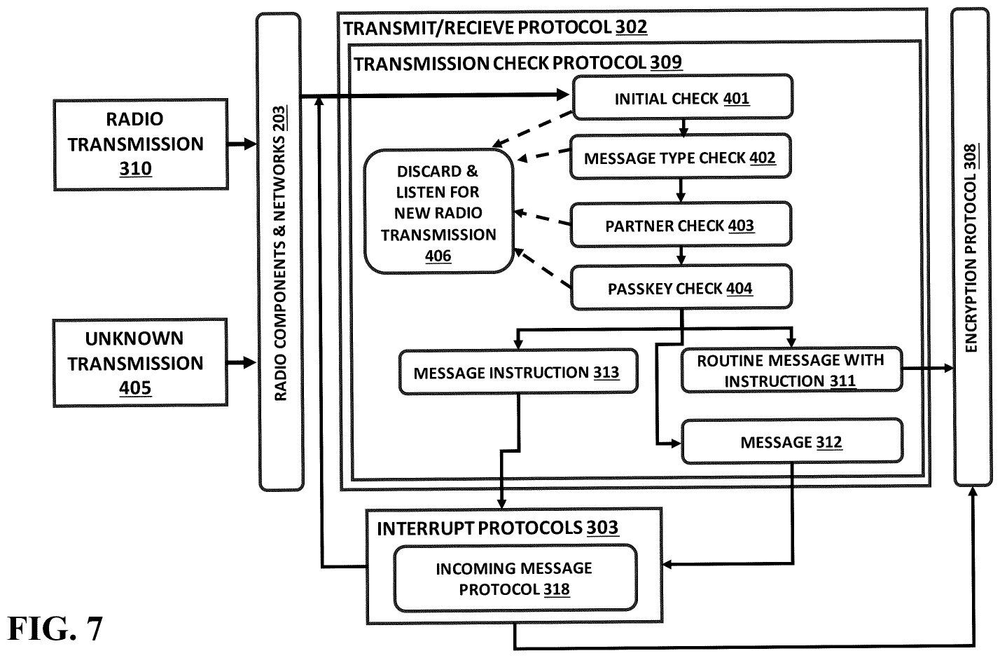

FIG. 7 is a diagram showing an example of how incoming radio transmissions 310 are handled to determine if they are intended for off-grid locator device 50, according to some aspects. As an example, all radio transmissions 310 may be passed through radio components & networks 203 which submits radio transmission 310 to transmission check protocol 309 within the transmit/receive protocol 302. As part of the transmission check protocol 309, first, an initial check protocol 401 checks the transmission to determine if it is in the correct format for the device (e.g., off-grid locator device 50) or whether it is an unknown transmission 405. If the transmission is known, the initial check 401 succeeds (indicated by the solid arrows) the information is sent to the message type check 402. In the event the transmission is determined to be unknown, the initial check fails (indicated by dashed arrows) whereby the transmission is discarded and the device (off-grid locator device 50) continues to listen for new radio transmissions (block 406).

The message type check 402 is responsible for identifying what is the intent of the transmission from known radio transmissions 310 (e.g., whether it is a routine message with instruction 311, message 312, or message instruction 313). If the message type check 402 succeeds, the information is then passed to the partner check 403, and if it fails the process proceeds to discard the transmission and continues to listen for new radio transmissions (block 406).

The partner check 403 is responsible for identifying if the known radio transmission 310 is intended for the particular device (e.g., off-grid locator device 50). The partner check 403 checks for the partner ID within the transmission 310 and compares it with its own internal ID that has been programmed into the firmware of the processor 62. If the ID within the transmission 310 and the ID of the device (e.g., off-grid locator device 50) programmed within the firmware of the processor 62 match, the partner check 403 succeeds and passes along the information to the passkey check 404. In the event that the IDs do not match, the partner check 404 fails and discards the transmission and continues to listen for new radio transmissions (block 406).

The passkey check 404 is similar to the partner check 403, except that the check and comparisons are conducted between the transmitted passkey and the device passkey programmed (e.g., off-grid locator device 50) into the firmware running on the processor 62. If all the checks 401-404 are successful, the information is passed to its respective instruction (e.g., routine message with instruction 311, message 312, or message instruction 313). It should be noted that routine messages 311 are passed to the encryption protocol 308 for un-encryption and further processing, as previously described with reference to FIG. 5.

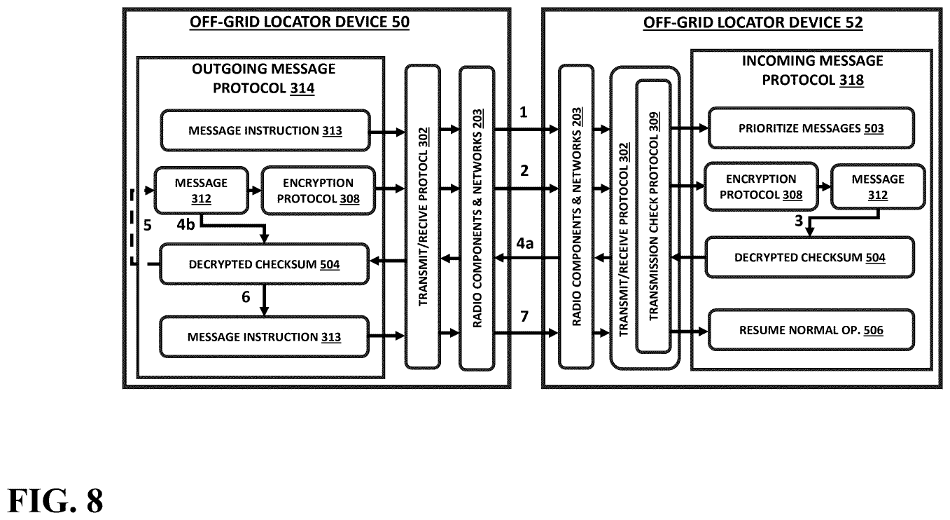

If a message instruction 313 was detected through checks 401-404, the incoming message protocol 318 is triggered. The protocol begins to listen to identify and select incoming message 312. Once the radio transmission 310 passes all checks 401-404, the incoming message protocol verifies that the message 312 was received correctly and passes it onto the encryption protocol 318 of the interrupt protocols 303 whereby further processing is required to ensure that the message was received correctly, which will hereafter be described in further detail in FIG. 8.

FIG. 8 is a diagram showing an example of a message sending and confirmation protocol between transmitting off-grid locator device 50 and a receiving off-grid locator device 52 that are paired before sending messages, according to some aspects. As shown in FIG. 8, the off-grid locator device 50 initiates the message instruction 313 through the outgoing message protocol 314. The message instruction is transmitted by the transmit/receive 302 protocol and radio components & networks 203 as indicated by path 1. This message instruction is received by the receiving off-grid locator device's 52 radio components & networks 203 and transmit/receive protocols 302, wherein, the transmission check protocol 309 checks the transmission to determine if it is of a known radio transmission 310 type. When the message instruction 313 is properly received, the receiving off-grid locator device 52 begins to prioritize messages 503 from the transmitter's partner ID by porting instructions on the processor 62 (e.g., another core of processor 62). This enables both off-grid locator device's 50 and 52 to transmit/receive messages and handle routine outgoing 307 and incoming messages 314 concurrently. The receiving off-grid locator device 52 then waits for a message to be transmitted from the transmitting device 501.

The transmitting off-grid locator device 50 then encrypts the message 312 through the encryption protocol 308 which is transmitted through path 2 to the receiving off-grid locator device 52. The message 312 is decrypted and received by the receiving off-grid locator device 52 where the decrypted checksum 504 is calculated and then transmitted back to the transmitting off-grid locator device 52 via path 4a for further verification. Concurrently, the transmitting off-grid locator device 50 also generates the decrypted checksum of the message indicated by path 4b before sending the encrypted message shown in path 2. However, in the event that the decrypted checksums between off-grid locator devices 50 and 52 do not match due to radio packet losses or interference, the message verification fails indicated by the dashed line of path 5, whereby transmitting off-grid locator device 50 proceeds to repeat paths 2-4.

In the event, that the decrypted checksums 504 match, a pass state indicated by path 6 is generated whereby transmitting off-grid locator device 50, transmits another message instruction 313 via path 7 to terminate listening for incoming messages with the transmitting device's ID. Once the receiving off-grid locator device 52 receives the message instruction 313 again, it resumes normal operation running only the transmit/receive 302 and interrupts 303 protocols concurrently on the processor (e.g., on a single core of the processor to consume less power).

In this way, messages can be transmitted and received by paired off-grid locator devices 50 and 52. As has been described, all of the off-grid locator devices should have the same or similar electronic structure and operational processes, firmware, software, etc., to implement these functions, such as, sending messages to one another.

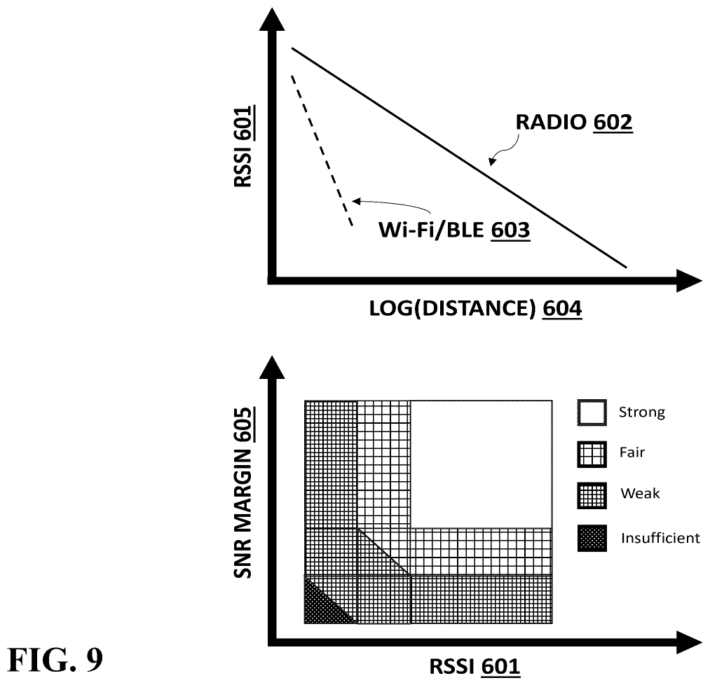

FIG. 9 are graphs showing a received signal strength indicator (RSSI) 601 versus the log-base-10 of the distance 604 (e.g., LOG (DISTANCE)) for the radio 602 and the Wi-Fi/BLE 603 frequencies, top graph, and the bottom graph shows the quality of the signal determined using the signal-to-noise ratio (SNR) margin 605 and the RSSI 601, according to some aspects. It should be appreciated that the two graph plots may be utilized in event corrections to geolocation-based determined paired partner distances 319 are desirable for optimization.

Referring to the top graph of FIG. 9, it can be seen that the Wi-Fi/BLE 603 signal provides better resolution of the distance based RSSI 601 as compared to the radio 602 curve. Therefore, corrections to the geolocation-based distances 319 using the relationship of 603 (Wi-Fi/BLE frequencies) are more reliable at shorter distances. This may be helpful for optimization of distance as the inaccuracies in the horizontal positioning of the GNSS/GPS receivers 210 affect geolocation-based distances 319 as the true distances between devices are reduced. Therefore, the Wi-Fi/BLE 603 curve can be used to supplement distances or apply corrections to determined geolocation-based distances 319, once shorter distances are determined, by the distance & bearing protocol 317.

The radio curve 602 provides a relationship between the RSSI 601 and log (distance) 604 that is applicable to distances that are farther compared to the Wi-Fi/BLE 603 curve. However, since the relationship between the RSSI 601 and the log (distance) 604 extends farther, it is by nature less accurate as compared to the Wi-Fi/BLE 603 curve at shorter distances. Therefore, the radio curve 602 can be utilized for corrections from medium distances where the Wi-Fi/BLE 603 is out of range or not applicable at medium to longer distances.

The bottom graph of FIG. 9 shows the signal quality using the SNR margin 605 and the RSSI 601 for both the radio 602 and Wi-Fi/BLE 603 curves. This plot determines if the relationships in the top graph of FIG. 6 can be utilized to correct for geolocation-based distances 319. The relationship of the RSSI 601 and the log (distance) 604 hold true only in the event that the environment does not obstruct the incoming signals. The SNR margin 605 is indicative of the obstruction of incoming signals and relates to the amount of external interference present compared to the RSSI 601. The bottom graph of FIG. 9 indicates that if there is sufficient SNR margin 605 and RSSI 601, that the signal is considered strong and the relationships in top graph of FIG. 9 can be utilized to correct for geolocation-based partner distances 319 at true short and medium distances between two devices using these relationships 602 and 603, and also holds true for fair signals. However, the graphs also indicate that there may be errors associated with the corrections to the distances at fair signal strengths. Further, for any regions within the weak and insufficient regions, the relationships in the top graph of FIG. 9 should not be used to correct for geolocation-based partner distances 319, and distances acquired should rely solely on two distinct geolocations obtained by GNSS/GPS receivers 210.

In one optional aspect, a ranging module 209 (e.g., FIG. 5) may be utilized in parallel with RSSI of the radio 602 and Wi-Fi/BLE 603 protocols to determine distance 604 and also the bearing 320 relative to paired devices (e.g., off-grid locator devices 50 and 52) with multiple high-speed ranging acquisitions. This can enhance short to medium range distance and bearing finding.

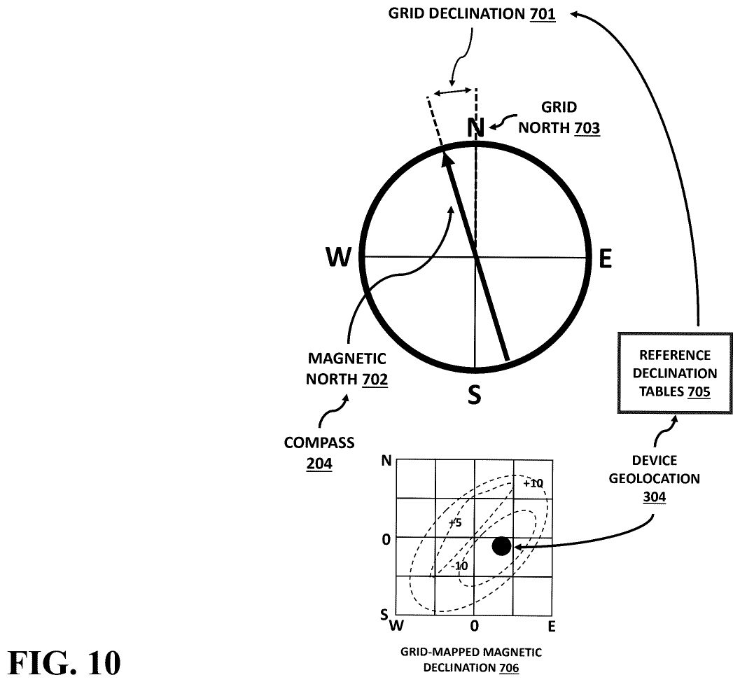

FIG. 10 is a diagram showing incorporation of grid declination 701 to correct for the difference between the compass' 204 magnetic north 702 and the grid north 703 using the off-grid locator device's 50 geolocation 304, according to some aspects. This correction may be utilized to guide users to the correct bearing 320 relative to the partner device (e.g., off-grid locator device 52). Since declinations vary by region and per annum due to shifting magnetic poles, tables can be saved on the processor's 62 internal memory or memory/flash 80 and can be updated by externally connected components 222 through wired connections through the USB port 103 or wirelessly through the Wi-Fi/BLE protocols of the processor 62.

To obtain accurate grid declination 701 values, the off-grid locator device's 50 geolocations 304 are used in conjunction with reference declination tables 705. This is visually depicted in the FIG. 10 as the device geolocation 304 referenced to the grid-mapped magnetic declination 706 that is directly applied to the grid declination 701 to sync the magnetic north 702 of the compass 204 to grid north 703 which aligns with the reference of the bearing relative to the partner device (e.g., off-grid locator device 52) determined by the distance & bearing protocol 317.

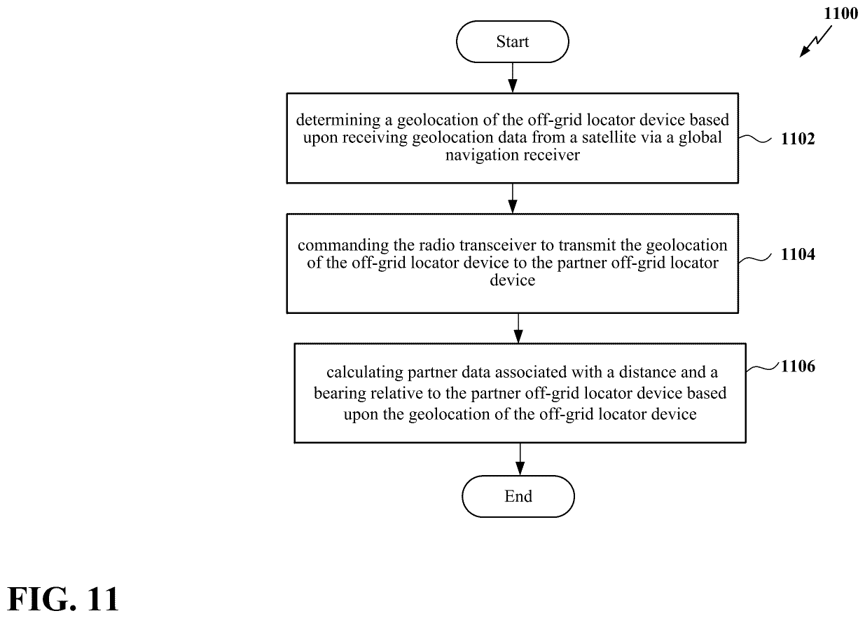

FIG. 11 is a flow chart of an example method 1100 operable at an off-grid locator device 50 to enhance tracking and messaging capabilities with a partner off-grid locator device 52, according to some aspects. At block 1102 the method includes: determining a geolocation of the off-grid locator device 50 based upon receiving geolocation data from a satellite via a global navigation receiver. At block 1104 the method includes: commanding a radio transceiver to transmit the geolocation of the off-grid locator device 50 to the partner off-grid locator device 52. At block 1106 the method includes: calculating partner data associated with a distance and a bearing relative to the partner off-grid locator device based upon the geolocation of the off-grid locator device.

In some examples, the method 1100 may be performed by the off-grid locator device 50 in conjunction with the partner off-grid locator device 52, as previously described, with implementations by processor 62 and other previously described system components, or by any suitable means for carrying out the described functions, as previously described.

As has been described, the off-grid locator device 50 is used to enhance tracking and messaging capabilities with a partner off-grid locator device 52. In one aspect the off-grid locator device 50 may include a processing system 60 that includes: a processor 62; a global navigation receiver 66; a radio transceiver 68; and memory 80. The global navigation receiver 66 and radio transceiver 68 may be coupled to antennas 70 for receipt and transmission data from satellites and other off-grid locator devices. Processor 62 may be coupled to the global navigation receiver 66, the radio transceiver 68, and memory 80 via bus 64. Memory 80 may include instructions 82 and data 84 for the processor 62 to implement functionality previously and to be hereafter described. Further, processor 62 may be coupled to a display 72 to display data to a user.

In one aspect, the global navigation receiver 66 receives geolocation data from a satellite 17 to determine a geolocation of the off-grid locator device 50. In one example, the geolocation may include longitude, latitude, and altitude of the off-grid locator device 50. As has been described, processor 62 is coupled to the global navigation receiver 66 and the radio transceiver 68. Processor 62 may be configured to: upon receiving the geolocation data from the global navigation receiver 66 and determining the geolocation of the off-grid locator device, commanding the radio transceiver 68 to transmit the geolocation of the off-grid locator device to the partner off-grid locator device 52. Processor 62 may be further configured to: calculate partner data associated with a distance and a bearing relative to the partner off-grid locator device 52 based upon the geolocation of the off-grid locator device. Processor 62, as utilized in the off-grid locator device 50, may be used to implement any one or more of the processes described herein. In some examples, the memory 80 may include instructions 82 and data 84 that may be utilized by the processor 62 when executing software to implement the functions described herein.

In one aspect, the radio transceiver 68 transmits and receives data in connection with the partner off-grid locator device 52 over a direct peer-to-peer radio connection, without utilizing Wi-Fi or cellular communication networks. In one example, the global navigation receiver 66 comprises a global navigation satellite system (GNSS) receiver or a global positioning system (GPS) receiver. In one example, the processor 62 is further configured to command the display 72 to display the off-grid locator device geolocation, the partner off-grid locator device geolocation, and the partner data associated with the distance and the bearing relative to the partner off-grid locator device. In one example, the processor 62 is further configured to command the off-grid locator device geolocation, the partner off-grid locator device geolocation, and the partner data associated with the distance and the bearing relative to the partner off-grid locator device be transmitted to an external component. In one example, an external component includes at least one of a server, a network, a mobile phone, an external display, a portable processing system, or a non-portable processing system. In one example, processor 62 is further configured to track and log: its own off-grid locator device geolocations and partner off-grid locator device geolocations. In one example, the processor 62 is further configured to command transmission of messages through the radio transceiver 68 to the partner off-grid locator device 52. In one example, the transmission and reception of messages are based upon peer-to-peer verification and confirmation over digital radio packets.

By utilizing these implementations by the off-grid locator device 50 and the partner off-grid locator device 52, tracking and messaging capabilities between the off-grid locator device 50 and partner off-grid locator device 52 are enhanced, and a robust solution to provide low latency tracking services, as well as messaging, at short to long ranges (e.g., less than 10 miles) between users utilizing the off-grid locator devices 50 and 52 in environments with poor connectivity or completely lacking traditional communication networks is provided. As previously described, with reference to FIG. 2, aspects described herein facilitate peer-to-peer tracking and messaging without the use of cellular or Wi-Fi networks between two or more off-grid locator devices 50 and 52, where there is no access to a base station. As an example, as previously described, a pair of hikers may be prevented by a mountain range 90 from access to a base station 12 and network 100. These types of solutions accommodate the growing demand for low-latency connectivity and location-based tracking for enthusiasts in outdoor environments, which often lack adequate cellular reception and/or access to Wi-Fi networks. It should be appreciated that although a pair of off-grid locator devices 50 and 52, have been particularly described, that any number of off-grid locator devices may be in communication with one another to exchange geolocation data, tracking information relative each other, and to exchange messages.

Further, because radio transceiver circuitry is utilized for short to long ranges (e.g., less than 10 miles), expensive cellular circuitry is not required for traditional cell-phone communication, such that the cost of off-grid locator devices are reduced. At the same time, the off-grid locator cell device can be connected to a user's cell-phone for cellular communication, when cellular communication is available. In particular, the off-grid locator devices can still be utilized in heavily flooded cell networks for geolocation, tracking, messaging, etc. Therefore, aspects described herein offer a viable pathway for reliable peer-to-peer tracking and communication in the absence and/or flooding of conventional communication networks in various contexts with extremely low latency.

As has been described, aspect of the invention facilitate peer-to-peer tracking and messaging without the use of cellular or Wi-Fi networks by transceiving digital radio packets containing geolocations (e.g., longitude, latitude, altitude) obtained by an onboard multi global navigation satellite systems (GNSS) receiver and user/device status between two or more devices (e.g., off-grid locator device 50 and partner off-grid locator device 52) with low latency. As has been described, it should be appreciated that any suitable number of off-grid locator devices may be in communication with one another to implement these functions. Furthermore, several additional key benefits have been previously described related to peer-to-peer message verification/confirmation over digital radio packets, methods to correct and improve upon geolocation-based distances through measured radio and Wi-Fi based RSSI values at short to medium distances, and in-situ compass corrections for navigation to paired devices by geolocation-based magnetic declination tables. Moreover, other key benefits related to message confirmation protocols have been described that combine checksums and port the message transmit/receiving onto a different core of the processor 62. This enables speedy message transmissions without the loss of incoming/outgoing geolocation data that enhances the features of the off-grid locator device 50. Although message confirmations for other communication forms, such as, generic cell-service have been established previously, this type of pathway offers a more accurate approach for message confirmation for peer-to-peer communications, especially at extremely low data bandwidths with high power efficiency.

Additional methods to improve upon determined distance between paired devices (e.g., off-grid locator device 50 and partner off-grid locator device 52), have also been described. For example, determining the distance using two distinct geolocations based on GNSS/GPS geolocations can lead to errors, particularly as real distances between the two devices are reduced. To account for the inaccuracies at shorter distances, additional tools such as the RSSI 601 values of the radio 602 and Wi-Fi/BLE 603 protocols can be weighed into distance calculations to account for inaccuracies in various situations, as has been previously described with reference to FIG. 9. Furthermore, navigating the bearing relative to a partner using a compass may also lead to errors if the local magnetic declination (e.g., grid declination) is not taken into account. As previously described with reference to FIG. 10, aspects of the invention use obtained device geolocations 304 paired with up-to-date reference declination tables 705 to sync the magnetic north 702 of the compass 204 to grid north 703. This factor aligns compass 204 readings relative to the reference of the bearing relative to the partner device 320 determined by the distance & bearing protocol 317, allowing users to navigate to paired devices precisely. As distances between the users are increased, the incorporation of the local grid declination 701 becomes exceedingly important in navigation.

It should be appreciated that aspects of the invention previously described may be implemented in conjunction with the execution of instructions or code by processors, circuitry, central processing units (CPUs), microcontrollers, controllers, control circuitry, etc. (e.g., processor 62, etc.). As an example, processors may operate under the control of a program, algorithm, code, routine, software, firmware, or the execution of instructions to execute methods or processes (e.g., processes in FIGS. 5-11) in accordance with the aspects previously described. For example, such a program may be implemented in firmware or software (e.g., stored in memory and/or other locations) (e.g., stored in memory 80) and may be implemented by processors, control circuitry, and/or other circuitry, these terms being utilized interchangeably. Further, it should be appreciated that the terms processor, microprocessor, circuitry, control circuitry, circuit board, controller, microcontroller, printed circuit board (PCB), etc., refer to any type of logic or circuitry capable of executing logic, commands, instructions, software, firmware, functionality, etc., which may be utilized to execute aspects of the invention.

The various illustrative logical blocks, processors, modules, and circuitry described in connection with the embodiments disclosed herein may be implemented or performed with a general purpose processor, a CPU, a specialized processor, a microprocessor, circuitry, a microcontroller, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor or any conventional processor, controller, microcontroller, circuitry, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module/firmware executed by processor 62, or any combination thereof. A software module may reside in RAM memory, flash memory, ROM memory, EPROM memory, EEPROM memory, registers, hard disk, a removable disk, a CD-ROM, non-transitory computer readable medium, or any other form of storage medium known in the art. An exemplary storage medium is coupled to the processor such the processor can read information from, and write information to, the storage medium. In the alternative, the storage medium may be integral to the processor.

It should be appreciated that computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. Computer-readable medium may reside in the processing system, external to the processing system, or distributed across multiple entities including the processing system. The computer-readable medium may be embodied in a computer program product. By way of example, a computer program product may include a computer-readable medium in packaging materials. In some examples, the computer-readable medium may be part of memory. Those skilled in the art will recognize how best to implement the described functionality presented throughout this disclosure depending on the particular application and the overall design constraints imposed on the overall system.

Of course, in the above examples, the circuitry included in the processor 62 is merely provided as an example, and other means for carrying out the described functions may be included within various aspects of the present disclosure, including but not limited to the instructions stored in memory 80, or any other suitable apparatus or means described in any one of the FIGS. 2-5 to implement, for example, processes, methods, algorithms, etc., and/or algorithms described herein in relation to FIG. 6-11. It should be appreciated these are just examples.

Several aspects of a wireless communication network have been presented with reference to an exemplary implementation. As those skilled in the art will readily appreciate, various aspects described throughout this disclosure may be extended to other telecommunication systems, network architectures and communication standards.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in any of the Figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the Figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

The previous description of the disclosed aspects is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. An off-grid locator device to enhance tracking and messaging capabilities with a partner off-grid locator device, the off-grid locator comprising:
a global navigation receiver to receive geolocation data from a satellite to determine a geolocation of the off-grid locator device;
a radio transceiver; and
a processor coupled to the global navigation receiver and the radio transceiver, the processor being configured to:
upon receiving the geolocation data from the global navigation receiver and determining the geolocation of the off-grid locator device,
commanding the radio transceiver to transmit the geolocation of the off-grid locator device to the partner off-grid locator device; and
calculating partner data associated with a distance and a bearing relative to the partner off-grid locator device based upon the geolocation of the off-grid locator device.

2. The off-grid locator device of claim 1, wherein, the radio transceiver transmits and receives data in connection with the partner off-grid locator device over a direct peer-to-peer radio connection, without utilizing Wi-Fi or cellular communication networks.

3. The off-grid locator device of claim 1, wherein, the global navigation receiver comprises a global navigation satellite system (GNSS) receiver or a global positioning system (GPS) receiver.

4. The off-grid locator device of claim 1, wherein, the geolocation includes longitude, latitude, and altitude.

5. The off-grid locator device of claim 1, further comprising a display, wherein the processor is further configured to command the display to display the off-grid locator device geolocation, the partner off-grid locator device geolocation, and the partner data associated with the distance and the bearing relative to the partner off-grid locator device.

6. The off-grid locator device of claim 1, wherein the processor is further configured to command the off-grid locator device geolocation, the partner off-grid locator device geolocation, and the partner data associated with the distance and the bearing relative to the partner off-grid locator device be transmitted to an external component.

7. The off-grid locator device of claim 6, wherein the external component includes at least one of a server, a network, a mobile phone, an external display, a portable processing system, or a non-portable processing system.

8. The off-grid locator device of claim 1, wherein the processor is further configured to track and log: off-grid locator device geolocations and partner off-grid locator device geolocations.

9. The off-grid locator device of claim 1, wherein the processor is further configured to command transmission of messages through the radio transceiver to the partner off-grid locator device.

10. The off-grid locator device of claim 9, wherein the transmission and reception of messages is based upon peer-to-peer verification and confirmation over digital radio packets.

11. A method operable at an off-grid locator device to enhance tracking and messaging capabilities with a partner off-grid locator device, the method comprising:
determining a geolocation of the off-grid locator device based upon receiving geolocation data from a satellite via a global navigation receiver;
commanding a radio transceiver to transmit the geolocation of the off-grid locator device to the partner off-grid locator device; and
calculating partner data associated with a distance and a bearing relative to the partner off-grid locator device based upon the geolocation of the off-grid locator device.

12. The method of claim 11, further comprising transmitting and receiving data via a radio transceiver with the partner off-grid locator device over a direct peer-to-peer radio connection, without utilizing Wi-Fi or cellular communication networks.

13. The method of claim 11, wherein, the global navigation receiver comprises a global navigation satellite system (GNSS) receiver or a global positioning system (GPS) receiver.

14. The method of claim 11, wherein, the geolocation includes longitude, latitude, and altitude.

15. The method of claim 11, further comprising: commanding a display to display the off-grid locator device geolocation, the partner off-grid locator device geolocation, and the partner data associated with the distance and the bearing relative to the partner off-grid locator device.

16. The method of claim 11, further comprising: commanding the off-grid locator device geolocation, the partner off-grid locator device geolocation, and the partner data associated with the distance and the bearing relative to the partner off-grid locator device be transmitted to an external component.

17. The method of claim 16, wherein the external component includes at least one of a server, a network, a mobile phone, an external display, a portable processing system, or a non-portable processing system.

18. The method of claim 11, further comprising tracking and logging off-grid locator device geolocations and partner off-grid locator device geolocations.

19. The method of claim 11, further comprising commanding transmission of messages through the radio transceiver to the partner off-grid locator device.

20. An off-grid locator device to enhance tracking and messaging capabilities with a partner off-grid locator device, the off-grid locator comprising:
means for determining a geolocation of the off-grid locator device based upon receiving geolocation data from a satellite via a global navigation receiver;
means for commanding a radio transceiver to transmit the geolocation of the off-grid locator device to the partner off-grid locator device; and
means for calculating partner data associated with a distance and a bearing relative to the partner off-grid locator device based upon the geolocation of the off-grid locator device.
